(19) United States
(12) Patent Application Publication
(10) Pub. No.: US 2010/0202708 A1
(43) Pub. Date: Aug. 12, 2010

(54) IMAGE PROCESSING APPARATUS AND IMAGE PROCESSING METHOD

(75) Inventor: Teruyuki Fukaya, Fukuoka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/702,474

(22) Filed: Feb. 9, 2010

(30) Foreign Application Priority Data
Feb. 12, 2009 (JP) 2009-029439

(51) Int. Cl. G06K 9/36

(52) U.S. Cl. 382/246

(57) ABSTRACT

A scanner is provided with encoding means for performing variable-length compression of scanned image data, memory means which is partitioned into an image memory area where the image data compressed to be variable-length is stored, and an administration table area where a BAT for administrating the image memory area is stored, in which the image memory area is partitioned into PMs made to correspond to each of bands 0 to 3 into which a document plane is divided at every predetermined width in a horizontal direction, and one or more EPMs allocatable to one of the bands 0 to 3, and image data processing means for storing compressed image data belonging to the bands 0 to 3, in the respective PMs 0 to 3, for storing the image data in sequence in the EPMs needed when compressed image data to be stored is greater than the PMs, and for setting identification information denoting the used EPMs as jump information of an administration table.

### BACKGROUND

1. Field of the Invention

The present invention relates to an image processing apparatus that stores document images as image data compressed to be variable-length in memory means, and an image processing method thereof.

2. Description of the Related Art

In the case in which a plurality of documents are continuously fed to a scanning device by an automatic sheet feeder, to be scanned, the documents are fed at an angle to the scanning device in some cases. In this case, because a document image portion included in the scanned image data is in a skewed state, it is necessary to perform correction of rotating the image data so as to bring the document image portion into a non-skewed state. Further, in the case in which a document size scannable by the scanning device is A3 size, and when a document to be scanned is A4 size, it is possible to scan images thereof in both cases of placing the document vertically and horizontally. In such a case, it is necessary to rotate the image data lengthways from sideways, and to rotate the image data sideways from lengthways.

When a line image sensor scans images of a document in units of predetermined lines in its horizontal scanning direction, the scanning device scans picture images of the entire document in sequence by moving the document or the line image sensor in the vertical scanning direction, which brings the image data to be stored in sequence in an image memory.

In this way, when an attempt is made to rotate the stored image data at an arbitrary angle, if the pixels of the document are in an adjacent positional relationship, the pixels may be adjacent on the image memory. However, in the case in which the pixels of the document are adjacent in the vertical scanning direction, the pixels are stored at separate positions in many cases. Accordingly, it takes a very long time to rotate the image data while accessing discrete image data.

Conventionally, with respect to the rotation of image data, scanned image data is divided into units of blocks to perform rotation processing for each block, which makes an attempt to shorten the processing time.

For example, in the image processing apparatus and method described in (Patent Document 1), image data in units of one block read out of an image memory is divided into respective color components to form color component blocks, the image data is written into work memories corresponding to the respective color component blocks while performing rotation processing separately for each color component block, the image data of the color component blocks after the rotation processing is read out of the respective work memories to be coupled together into a data format, to be a rotation processing result in units of one block, that is written into a page memory to be at a position after rotation processing in units of blocks.

Patent Document 1: JP-A-2006-270423

However, in the image processing apparatus described in (Patent Document 1), because the scanned image data is stored in the image memory and the image data in units of one block read out of the image memory is stored in the work memories corresponding to the respective blocks, it is necessary to provide not only the image memory, but also the work memories, which require a large-capacity memory.

Provided that image data is encoded to be compressed, the capacity of an image memory can be reduced. However, because compressed image data varies in data length according to the contents of image data, a data capacity of each block varies even if the image data is divided into blocks. Therefore, it is necessary to prepare in accordance with a capacity in a state of the worst compression rate, thereby gapping in the image data can occur, which is wasteful.

### SUMMARY

Then, it is an object of the present invention to provide an image processing apparatus that is capable of rationally storing image data compressed to be variable-length in memory means, and an image processing method thereof.

An image processing apparatus of the present invention is provided with encoding means for performing variable-length compression of image data that a line image sensor scans images of a document in units of predetermined lines in a horizontal scanning direction, memory means which is partitioned into an image memory area where the image data compressed to be variable-length is stored, and an administration table area where an administration table for administrating the image memory area is stored, in which, with a horizontal scanning direction or a vertical scanning direction perpendicular to the horizontal scanning direction being as a first direction, the image memory area is partitioned into an area for disposing a page memory of a fixed size made to correspond to each of first rectangular areas into which a document plane is divided at every predetermined width in the first direction, and an area for disposing one or more extended page memories of a fixed size allocatable to one of the first rectangular areas, and image data processing means for storing image data belonging to the first rectangular areas, in the page memories corresponding to the respective first rectangular areas, for storing the image data in sequence in the extended page memories needed when image data to be stored is greater than the page memories, and for setting identification information denoting the used extended page memories with an administration table.

Further, an image processing method of an image processing apparatus of the present invention includes an encoding step of performing variable-length compression of image data that a line image sensor scans images of a document in units of predetermined lines in a horizontal scanning direction, a step of storing the image data belonging to the first rectangular areas in page memories corresponding to the first rectangular areas of memory means which is partitioned into an image memory area where the image data compressed to be variable-length is stored, and an administration table area where an administration table for administrating the image memory area is stored, in which, with a horizontal scanning direction or a vertical scanning direction perpendicular to the horizontal scanning direction being as a first direction, the image memory area is partitioned into an area for disposing a page memory of a fixed size made to correspond to each of first rectangular areas into which a document plane is divided at every predetermined width in the first direction, and an area for disposing one or more extended page memories of a fixed size allocatable to one of the first rectangular areas, a step of storing the image data in sequence in extended page memories needed when image data to be stored is greater than the page memories, and a step of setting identification information denoting the used extended page memories with an administration table.

According to the present invention, when image data compressed to be variable-length is fit within the page memories, there is no need to use the extended page memories, and when the image data is greater than the size of the page memories, the image data is stored in one or more extended page memories needed so as to be readable on the basis of the identification information denoting the used extended page memories which are set with the administration table. Therefore, it is possible to store the image data in the memory means with less waste. Therefore, according to the present invention, it is possible to store image data compressed to be variable-length in the memory means with less waste.

### BRIEF DESCRIPTION OF THE DRAWINGS

FIG. 1 is a block diagram showing the configuration of an image processing apparatus according to an embodiment of the present invention.

FIG. 2 is a diagram showing a memory map of memory means.

FIG. 3 is a diagram for explanation of bands and blocks on a document plane.

FIG. 4 is a diagram showing page memories and extended page memories where compressed image data is stored.

FIG. 5 is a diagram showing the relationship of the page memories and the extended page memories to an administration table.

FIG. 6 is the flowchart for explanation of the operation of the image processing apparatus according to the embodiment of the present invention.

### DETAILED DESCRIPTION

A first aspect of the present invention is An image processing apparatus, comprising an encoder performing variable-length compression of image data, the image data being formed by scanning images of a document by a line image sensor in units of predetermined lines in a horizontal scanning direction; a memory partitioned into an image memory area where the image data compressed to be variable-length by the encoder is stored, and an administration table area where an administration table for administrating the image memory area is stored, in which, with a horizontal scanning direction or a vertical scanning direction being as a first direction, the image memory area is partitioned into an area for disposing a page memory of a fixed size made to correspond to each of first rectangular areas into which a document plane is divided at every predetermined width in the first direction, and an area for disposing one or more extended page memories of a fixed size allocatable to one of the first rectangular areas; and an image data processor storing image data belonging to the first rectangular areas of the memory, in the page memories corresponding to the respective first rectangular areas, for storing the image data in sequence in the extended page memories needed when image data to be stored is greater than the page memories, and for setting identification information denoting the used extended page memories with an administration table.

According to the first aspect of the present invention, the image data processing means first stores the image data compressed to be variable-length, which belongs to the first rectangular areas in a page memory, and when the image data cannot be stored within the page memory, the image data processing means stores the image data by use of extended page memories needed until it can be stored. Then, the image data processing means sets identification information denoting the used extended page memories with the administration table.

Accordingly, when image data compressed to be variable-length is fit within the page memories, there is no need to use the extended page memories, and when the image data is greater than the size of the page memories, the image data is stored in one or more extended page memories needed so as to be readable on the basis of the identification information denoting the used extended page memories which are set with the administration table. Therefore, it is possible to store the image data in the memory with less waste.

A second aspect of the present invention is the image processing apparatus in which, with the first rectangular areas being divided at every predetermined length in a second direction perpendicular to the first direction, to be block areas, the image data processor sets initial addresses of the image memory area at which image data corresponding to the respective block areas is stored, with the administration table, and sets identification information denoting an extended page memory used so as to correspond to a block area whose image data is more than the page memory at the time of storing the image data of the first rectangular area in a page memory, with the administration table.

According to the second aspect of the present invention, an initial address of the image memory area where the image data is stored, and identification information denoting an extended page memory are administrated by the administration table for each block area, which makes it possible for the image readout unit to simply read out the image data belonging to desired blocks even in the case of image data compressed to be variable-length from page memories or extended page memories.

A third aspect of the present invention is the image processing apparatus in which, at the time of storing image data in an extended page memory, when the image data is still more than the extended page memory, the image data processor sets identification information denoting an extended page memory additionally used so as to correspond to a block area whose image data is more than the extended page memory, with the administration table.

According to the third aspect of the present invention, when image data of each block area is stored in an extended page memory, to be still more than the extended page memory, identification information denoting an extended page memory additionally used is set with the administration table, which makes it possible for the image readout unit to simply read out the image data compressed to be variable-length from the extended page memory additionally used.

A fourth aspect of the present invention is an image processing method of an image processing apparatus that includes an encoding step of performing variable-length compression of image data that a line image sensor scans images of a document in units of predetermined lines in a horizontal scanning direction, a step of storing the image data belonging to the first rectangular areas in page memories corresponding to the first rectangular areas of memory which is partitioned into an image memory area where the image data compressed to be variable-length is stored, and an administration table area where an administration table for administrating the image memory area is stored, in which, with a horizontal scanning direction or a vertical scanning direction perpendicular to the horizontal scanning direction being as a first direction, the image memory area is partitioned into an area for disposing a page memory of a fixed size made to correspond to each of first rectangular areas into which a document plane is divided at every predetermined width in the first direction, and an area for disposing one or more extended page memories of a fixed size allocatable to one of the first rectangular areas, a step of storing the image data in sequence in extended page memories needed when image data to be stored is greater than the page memories, and a step of setting identification information denoting the used extended page memories with an administration table.

According to the fourth aspect of the present invention, the image data compressed to be variable-length, which belongs to the first rectangular areas is first stored in a page memory, and when the image data cannot be stored within the page memory, the image data is stored by use of extended page memories needed until it can be stored. Then, identification information denoting the used extended page memories is set with the administration table. When image data compressed to be variable-length is fit within a page memory, there is no need to use extended page memories, and when the image data is greater than the size of the page memory, the image data is stored in one or more extended page memories needed so as to be readable on the basis of the identification information denoting the used extended page memories which are set with the administration table. Therefore, it is possible to store the image data in the memory with less waste.

### Embodiment

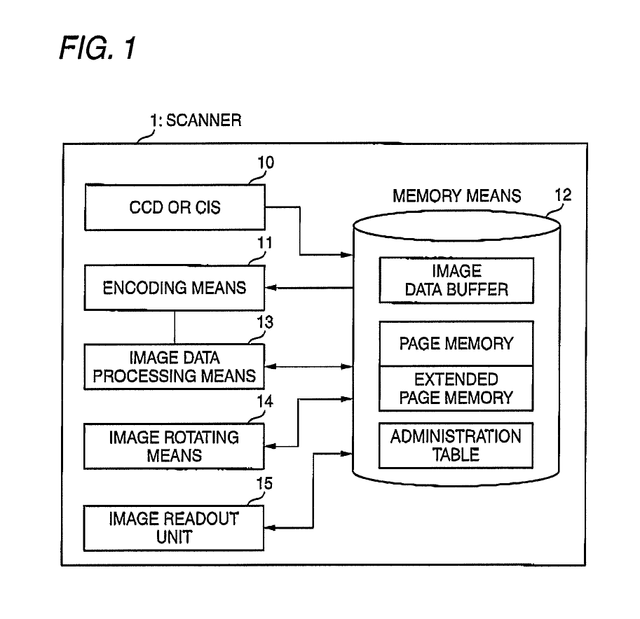

An image processing apparatus according to an embodiment of the present invention will be described with reference to the drawings by use of a scanner as an example. FIG. 1 is a block diagram showing the configuration of the image processing apparatus according to the embodiment of the present invention. In addition, in FIG. 1, only the main portions of a scanner 1 are shown, and interface means for connecting to a computer that sets scanning of images of a document and scanning conditions, a transmission buffer for the time of transmitting image data to a computer, and the like are not shown.

In FIG. 1, the scanner 1 in the embodiment of the present invention is provided with a line image sensor 10 that scans images of a document in full color in units of predetermined lines in its horizontal scanning direction, encoding means 11 for performing variable-length compression of image data scanned by the line image sensor 10, memory means 12 where the image data compressed to be variable-length (hereinafter called “compressed image data”) is stored, image data processing means 13 for storing compressed image data in the memory means 12, and for setting an administration table for administrating the compressed image data, image rotating means 14 for performing processing such as rotation for image data that the compressed image data stored in the administration table composing the memory means 12 is decoded, and an image readout unit 15 that decodes and reads out the compressed image data in the administration table.

The line image sensor 10 is composed of a general solid-state image sensing device such as an optical reduction system CCD (Charge Coupled Device) or a contact sensor system CIS (Contact Image Sensor).

In addition, in the case in which the scanner 1 is of a flatbed type, a document is fixed on a transparent document bench, and therefore, the line image sensor 10 scans images of the document in units of predetermined lines in the horizontal scanning direction while moving in the vertical scanning direction. Further, in the case in which the scanner 1 is of a sheet feeder type, the line image sensor 10 is fixed, and therefore, the line image sensor 10 scans images of the document in units of predetermined lines in the horizontal scanning direction while moving a document in the vertical scanning direction by a conveyor roller. In addition, the line image sensor 10 in the present embodiment scans images in units of one line in the horizontal scanning direction. However, the line image sensor 10 may be configured to scan images in units of a plurality of lines, for example, in units of three lines.

The encoding means 11 has a function of performing variable-length compression of image data in order to reduce a capacity of entire image data to be processed. For variable-length compression, for example, JPEG (Joint Photographic Experts Group) may be adopted. With use of JPEG, image data can be compressed into approximately one-tenth to one-hundredth in capacity depending on contents of a document.

In the memory means 12, compressed image data and an administration table for administrating the compressed image data are stored.

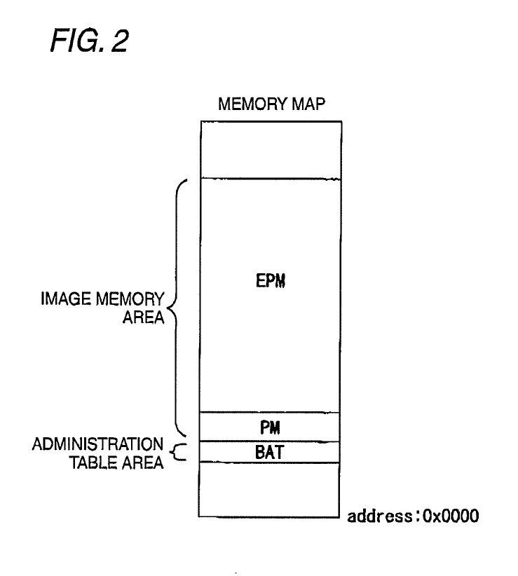

Here, the concept of areas divided for convenience of storage of compressed image data in the memory means 12 will be described on the basis of FIG. 2. FIG. 2 is a diagram showing a memory map of the memory means. FIG. 2 is for explanation of a memory area in the memory means 12 shown in FIG. 1, and the memory area is partitioned into an image memory area where image data compressed to be variable-length is stored and an administration table area where an administration table for administrating the image memory area is stored. The image memory area is partitioned into an area where page memories (hereinafter called PMs (Page Memories)) are disposed, and an area where extended page memories (hereinafter called EPMs (Extended Page Memories)) are disposed. The administration table (hereinafter called BAT (Block Address Table)) for administrating the image memory area is provided in the administration table area.

Because the compressed image data stored in the image memory area in the memory means 12 is compressed to be variable-length by the encoding means 11, its data length differs in each line. Accordingly, at the time of storing the compressed image data in sequence in the PMs, for respective blocks composing a PM, in some cases, the compressed image data can be fit or cannot be fit within the blocks.

Then, in the case in which there are blocks within which compressed image data cannot be fit, the data which cannot be fit within the blocks is stored in EPMs, and the relationship between the PMs and the EPMs is sorted in the BAT.

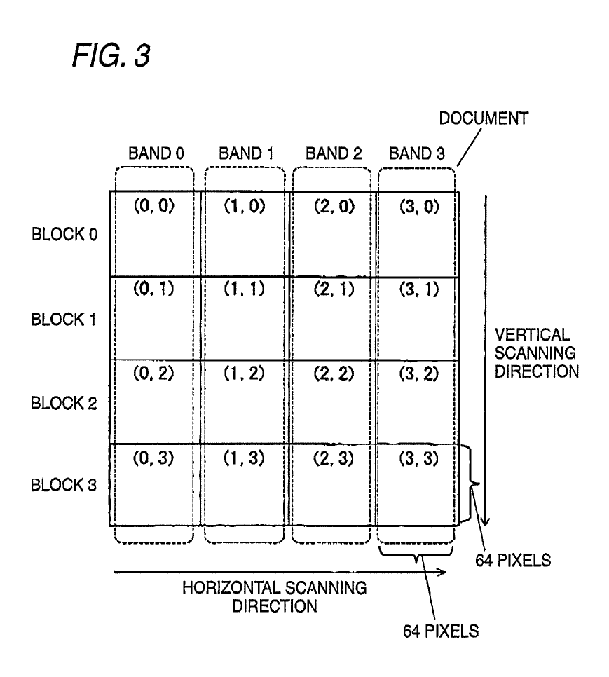

A PM has a size of 512 bytes that is a fixed size, and is provided so as to correspond to each band. Here, a band will be described in detail on the basis of FIG. 3. FIG. 3 is a diagram for explanation of bands and blocks on a document plane.

In the present embodiment, rectangular areas into which a document plane is divided at every predetermined width in the horizontal scanning direction (first direction) (first rectangular areas) are called bands. In the example of FIG. 3, the document plane is divided into four bands of bands 0 to 3. Then, areas into which the respective bands 0 to 3 are divided at every predetermined length in the vertical scanning direction (second direction) are blocks. In the example of FIG. 3, the respective bands 0 to 3 are divided into four blocks (blocks 0 to 3). The respective blocks 0 to 3 into which the respective bands (0 to 3) are divided, i.e., the blocks (m, n) (m=0 to 3, n=0 to 3) are the minimum units for administrating the compressed image data.

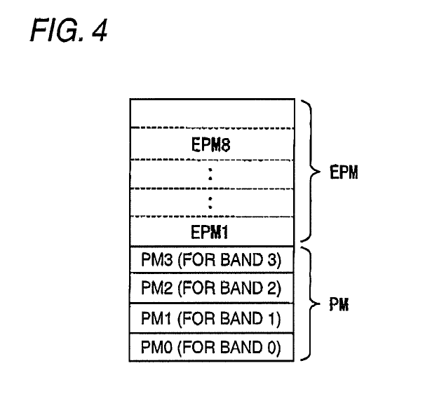

FIG. 4 is a diagram showing the PM and the EPM where compressed image data is stored. As shown in FIG. 4, in the PM, PMs 0 to 3 are provided so as to correspond to the bands 0 to 3. That is, the PM0, the PM1, the PM2, and PM3 are respectively allocated to the band 0, the band 1, the band 2, and the band 3.

An EPM is a fixed area having a size of 512 bytes, and an area additionally allocated to the PM in the case in which compressed image data cannot be stored within a PM. In FIG. 4, any one of the EPM1 to EPM8 is allocated to any one of the bands 0 to 3. That is, in the case in which compressed image data cannot be stored within a PM, the EPM1 is not necessarily allocated to the PM1, and the EPM3 may be allocated to the PM1 in some cases.

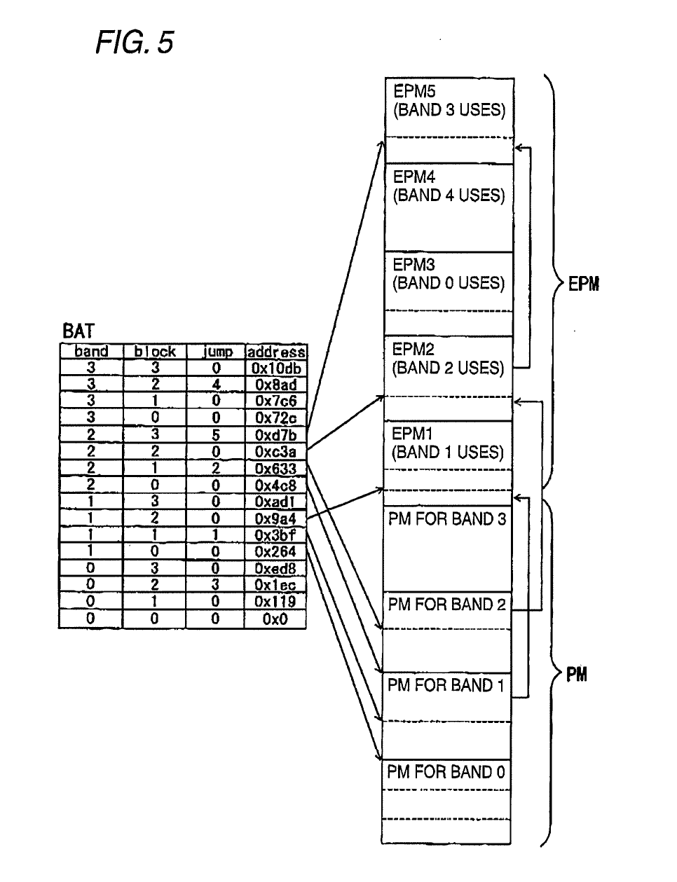

FIG. 5 is a diagram showing the relationship of PM and EPM to a BAT. As shown in FIG. 5, the BAT is a table that the respective bands 0 to 3 are respectively divided into the blocks 0 to 3, and jump information denoting whether an EPM is additionally used for each PM of a plurality of blocks (m, n) composing the respective bands, and address information denoting initial addresses of data stored in the PMs of the respective bands 0 to 3, or initial addresses of data following those in the case in which an EPM is added to its previous block, are stored therein.

Further, as shown in FIG. 1, an image data buffer in which image data scanned by the line image sensor 10 is temporarily stored is provided in the memory means 12.

The image data processing means 13 stores image data belonging to bands 0 to 3 in the PMs corresponding to the respective bands 0 to 3. In the case in which an amount of image data to be stored is more than the sizes of the PMs, the portions more than the sizes of the PMs are stored in sequence in EPMs, and the numbers of the used EPMs are set with the BAT as identification information.

The image rotating means 14 is capable of rotating image data at an arbitrary angle.

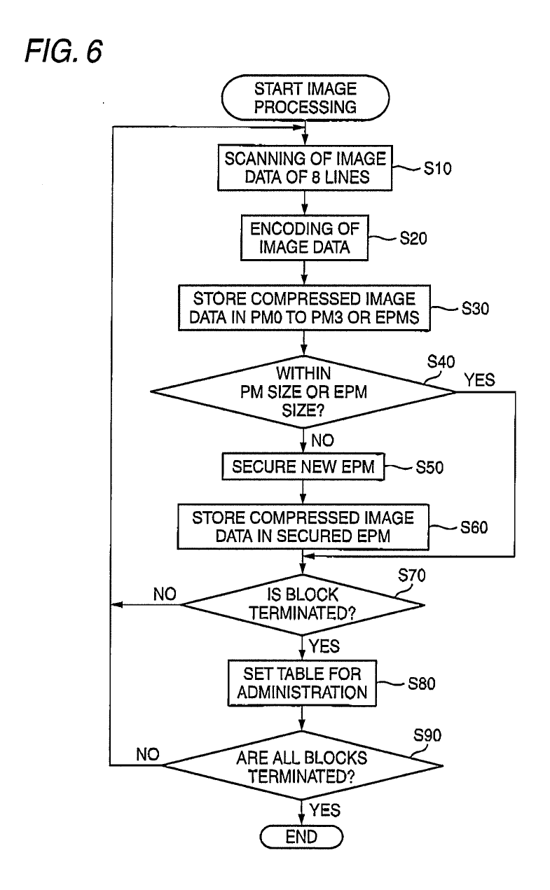

The operation of the scanner according to the embodiment of the present invention configured as described above will be described on the basis of a flowchart of FIG. 6. FIG. 6 is the flowchart for explanation of the operation of the image processing apparatus according to the embodiment of the present invention.

In addition, in the present embodiment, a description will be given by use of the case in which, as shown in FIG. 3, the bands that the horizontal scanning direction is divided into four at every 64 pixels, are divided into four blocks at every 64 pixels in the vertical scanning direction, as an example.

First, image data of 8 lines is scanned by the line image sensor 10 (Step S10). The scanned image data is stored in the image data buffer in the memory means 12, and the image data of the 8 lines for the first time is stored in the respective blocks 0 in the bands 0 to 3.

That is, the image data scanned by the line image sensor 10 is stored in order of the blocks (0, 0), (1, 0), (2, 0), (3, 0), (0, 1), (1, 1), (2, 1), (3, 1), (0, 2), (1, 2), (2, 2), (3, 2), (0, 3), (1, 3), (2, 3), and (3, 3) of the PMs shown in FIG. 3.

Next, the encoding means 11 performs compression of the image data stored in the image data buffer at every 64 pixels, i.e., at every bands 0 to 3 along the horizontal scanning direction (Step S20).

Next, the image data processing means 13 stores the compressed image data in the image memory area. Here, because this is for the first time, the compressed image data is stored in the blocks 0 in the bands 0 to 3. That is, the image data processing means 13 first stores the compressed image data belonging to the bands 0 in the PM0, and next stores the compressed image data belonging to the band 1 in the PM1, and hereinafter stores the compressed image data in sequence in the PM2 and the PM3 in the same way (Step S30).

The image data processing means 13 judges whether the storage is terminated because the compressed image data belonging to the respective bands 0 to 3 is respectively less than or equal to the sizes of the PMs 0 to 3, that is not more than the respective areas of the PMs 0 to 3. Or, if the image data processing means 13 stores the compressed image data in the EPMs, the image data processing means 13 judges whether the storage is terminated without the compressed image data being not more than the respective areas of the EPMs where it is stored (Step S40). When the compressed image data is not more than the respective PMs 0 to 3 or the EPMs, to be able to be stored therein, the operation proceeds to step S70.

In step S70, it is judged whether scanning is terminated in units of blocks (m, n). When the scanning is not terminated, the operation proceeds to step S10 in order to scan image data of the following 8 lines by the line image sensor 10. Image processing for one block is terminated by repeating the operations from step S10 to step S70 eight times.

When the image processing in units of blocks is terminated, the image data processing means 13 sets the initial addresses at which the compressed image data is stored as address information. Further, because no EPMs are used for the blocks 0 in the bands 0 to 3, 0 is set as jump information (Step S80).

In the BAT shown in FIG. 5, address information is expressed as relative addresses from the initial addresses of the image memory area, and the block 0 in the band 0 is 0x0 block address, the block 0 in the band 1 is 0x264 block address, the block 0 in the band 2 is 0x4c8 block address, and the block 0 in the band 3 is 0x72c block address.

Next, the image data processing means 13 judges whether the image processings for the blocks 0 in all the bands are terminated (Step S90). When the image processings are not terminated, the operation proceeds to step S10.

In step S10 in the next cycle, the image data of 8 lines in the second block is scanned by the line image sensor 10. The image data of 8 lines for the second time respectively belongs to the respective blocks 1 in the bands 0 to 3. The scanned image data is stored in the image data buffer in the memory means 12.

Next, the encoding means 11 performs compression of the image data stored in the image data buffer (Step S20). Next, the image data processing means 13 stores the compressed image data in sequence in the respective PMs 0 to 3 in the bands 0 to 3 (Step S30).

In FIG. 5, it is assumed that the PM1 is filled up to its size in the process of storing the compressed image data belonging to the bands 1 in the PM1. That is, only the PM1 of a fixed size is not capable of storing the compressed image data of the block 1 successively after the compressed image data of the block 0 in the band 1 is stored. Accordingly, the image data processing means 13 secures one EPM in step S50, and stores compressed image data spilled over from the PM1 of the block 1 in the secured first EPM1 in step S60.

Then, when the image processing for one block is terminated by repeating the operations from step S10 to step S70, the image data processing means 13 sets the respective initial addresses of the blocks 1 as address information of the BAT, and “1” as identification information denoting the first EPM1 secured in step S50 is set as jump information denoting that the EPM is used (Step S80). Because numbers for identifying the EPMs are stored as jump information, the numbers are allocated in number order from 1 to the EPMs.

When the setting of the BAT is completed, the image data processing means 13 judges whether the processings for all the blocks are terminated (Step S90). When the processings are not terminated, the operation proceeds to step S10. In this way, the image data processing means 13 stores the compressed image data in the image memory area in sequence from the blocks 0 to the blocks 3, and sets whether the EPMs are used.

As an example of the BAT shown in FIG. 5, the example in which the bands 0 to 3 are respectively divided into four blocks 0 to 3 upward from the lowermost stage, and the compressed image data is stored in number order from the blocks 0, is shown.

As described above, the image data scanned by the line image sensor 10 is stored in order from a block of the blocks 0 in the band 0 of the PM shown in FIG. 3, i.e., from the block (0, 0), and are thereafter stored in order of (1, 0), (2, 0), (3, 0), (0, 1), . . . , (3, 3).

The lowermost stage shows the initial address “0x0” of the block 0 in the band 0, and because the data is fit within the PM0, the field for jump information is “0.” The following data is stored in the block 0 in the band 1, and because the data is fit within the PM1, the field for jump information is “0.”

In the same way, the field for jump information of the block 0 in the band 2 is “0,” the field for jump information of the block 0 in the band 3 is “0,” and the field for jump information of the block 1 in the band 0 is “0,” However, because the data of the block 1 in the band 1 cannot be fit within the PM1, and the data which cannot be fit within the PM1 is stored in the EPM1, 1 is input in the field for jump information of the block 1 in the band 1. Hereinafter, the fields for jump information of the blocks are set in the same way.

Next, the case in which the compressed image data stored in the memory means 12 is read out, to be rotated by the image rotating means 14 will be described. In addition, the following description is given such that the initial address is 0x000 block address of the image memory area.

For example, in the case in which the block 0 in the band 2 is taken out, the address information thereof is read out with reference to the BAT. In the example of FIG. 5, the initial address at which the compressed image data of the block 0 in the band 2 is stored is 0x4c8 block address on the basis of the address information. Further, the initial address at which the compressed image data of the block 1 in the band 2 is stored is 0x633 block address.

Accordingly, 0x16b bytes (363 bytes) from the 0x4c8 block address to the 0x633 block address are the compressed image data of the block 0 in the band 2. At the time of reading out the compressed image data, 363 bytes from the 0x4c8 block address located in the PM2 are read out. Provided that the 363 bytes are read out by DMA (Direct Memory Access), it is possible to read it out at high speed without a load on the program.

Next, the case in which the image readout unit reads out the block 1 in the band 2 will be described. Referring to the BAT, the initial address at which the compressed image data of the block 0 in the band 2 is stored is 0x633 block address. Further, the initial address at which the compressed image data of the block 2 in the band 2 is stored is 0xc3a block address. However, because “2” is set as jump information, the EPM2 is referred to. Because the PMs and EPMs respectively have their fixed sizes, it is easy to find out the initial address of the EPM2. Provided that the respective initial address of the PMs and the EPMs are tabled to be prepared in the memory means 12, it is easier to find out the initial address of the EPM2.

Accordingly, provided that the image readout unit reads out the 0x633 block address of the PM2 to the final address of the PM2, and the initial address of the EPM2 to the previous address of the 0xc3a block address, it is possible to acquire the compressed image data of the block 1 in the band 2.

When the compressed image data of the block 1 in the band 2 is acquired, the image readout unit decodes the compressed image data into the original image data, and the image data is rotated at an arbitrary angle by the image rotating means 14.

In this way, the image data processing means 13 first stores the image data compressed to be variable-length, which belongs to the bands 0 to 3, in the PMs 0 to 3. In the case in which the image data cannot be stored within the PMs 0 to 3, the image data is stored by use of EPS needed until it can be stored therein. When the image data can be fit within the PMs, there is no need to use the EPMs. By use of one or more EPMs necessary according to a size of compressed image data, there is no need to determine the sizes of the PMs in order for all the compressed image data of the blocks to be fit within only the PMs in accordance with a state of the worst compression rate. Accordingly, even if the respective areas where compressed image data is stored have their fixed sizes, it is possible to reduce waste. Further, provided that identification information denoting EPMs used for the BAT is set, it is possible to easily identify the EPMs used successively after the PMs.

In addition, in the present embodiment, the rectangular areas into which the horizontal scanning direction is divided at every predetermined width may serve as bands. However, rectangular areas into which the vertical scanning direction is divided at every predetermined width may serve as bands. Further, in the present embodiment, the blocks may serve as minimum units for administrating the compressed image data. However, the bands may serve as minimum units. In this case, because a plurality of EPMs may be allocated to one band as the band 2 in the BAT shown in FIG. 5, provided that one or more pieces of jump information are provided to each band, it is possible to respond to it. Even when the bands may serve as minimum units, if the image data can be fit within the PMs, the EPMs are unnecessary, and if the data is more than the PMs, the EPMs are allocated thereto, which brings about the effect of the present invention.

In accordance with the present invention, because image data compressed to be variable-length can be stored in the memory means with less waste, the present invention is suitable for an image processing apparatus that stores document images as compressed image data in the memory means, and an image processing method thereof.

What is claimed is:

1. An image processing apparatus, comprising:
an encoder performing variable-length compression of image data, the image data being formed by scanning images of a document by a line image sensor in units of predetermined lines in a horizontal scanning direction;
a memory partitioned into an image memory area where the image data compressed to be variable-length by the encoder is stored, and an administration table area where an administration table for administrating the image memory area is stored, in which, with a horizontal scanning direction or a vertical scanning direction being as a first direction, the image memory area is partitioned into an area for disposing a page memory of a fixed size made to correspond to each of first rectangular areas into which a document plane is divided at every predetermined width in the first direction, and an area for disposing one or more extended page memories of a fixed size allocatable to one of the first rectangular areas; and
an image data processor storing image data belonging to the first rectangular areas of the memory, in the page memories corresponding to the respective first rectangular areas, for storing the image data in sequence in the extended page memories needed when image data to be stored is greater than the page memories, and for setting identification information denoting the used extended page memories with an administration table.

2. The image processing apparatus according to claim 1, wherein, with the first rectangular areas of the memory being divided at every predetermined length in a second direction perpendicular to the first direction, to be block areas, the image data processor sets initial addresses of the image memory area at which image data corresponding to the respective block areas is stored, with the administration table, and sets identification information denoting an extended page memory used so as to correspond to a block area whose image data is more than the page memory at the time of storing the image data of the first rectangular area in a page memory, with the administration table.

3. The image processing apparatus according to claim 2, wherein at the time of storing image data in an extended page memory, when the image data is still more than the extended page memory, the image data processor sets identification information denoting an extended page memory additionally used so as to correspond to a block area whose image data is more than the extended page memory, with the administration table.

4. An image processing method of an image processing apparatus comprising:
an encoding step of performing variable-length compression of image data, the image data being formed by scanning images of a document by a line image sensor in units of predetermined lines in a horizontal scanning direction;
a step of storing the image data belonging to the first rectangular areas in page memories corresponding to the first rectangular areas of memory which is partitioned into an image memory area where the image data compressed to be variable-length is stored, and an administration table area where an administration table for administrating the image memory area is stored, in which, with a horizontal scanning direction or a vertical scanning direction perpendicular to the horizontal scanning direction being as a first direction, the image memory area is partitioned into an area for disposing a page memory of a fixed size made to correspond to each of first rectangular areas into which a document plane is divided at every predetermined width in the first direction, and an area for disposing one or more extended page memories of a fixed size allocatable to one of the first rectangular areas;
a step of storing the image data in sequence in extended page memories needed when image data to be stored is greater than the page memories; and
a step of setting identification information denoting the used extended page memories with an administration table.
